(19) United States
(12) Patent Application Publication
(10) Pub. No.: US 2009/0274319 A1
(43) Pub. Date: Nov. 5, 2009

(54) AUDIO AMPLIFIER

(76) Inventor: Chih-Haur Huang, Sinshih Township (TW)

Correspondence Address: HAYES SOLOWAY P.C., 3450 E. SUNRISE DRIVE, SUITE 140, TUCSON, AZ, 85718, US

(21) Appl. No.: 12/115,138

(22) Filed: May 5, 2008

(51) Int. Cl. H04B 15/00

(52) U.S. Cl. 381/94.5

(57) ABSTRACT

An audio amplifier includes an amplifying circuit, a bias control circuit, and a decoupling device. The amplifying circuit amplifies an audio signal. The bias control circuit provides at least one bias voltage for the amplifying circuit according to a power down signal, in which the power down signal represents that the audio amplifier is powered on or powered down. The decoupling device reduces the damping phenomenon of the bias voltage caused by powering on or powering down the audio amplifier.

### BACKGROUND

1. Field of Invention

The present invention relates to a power amplifier. More particularly, the present invention relates to a power amplifier for amplifying an audio signal.

2. Description of Related Art

As the name suggests, the audio amplifier amplifies audio signals. These audio amplifiers typically include an audio input stage and an audio output stage. The audio input stage is connected to some type of audio source and the audio output stage is connected to the audio device such as a speaker. These audio amplifiers receive audio signals from the audio source, amplify those audio signals, generate audio current signals based on those amplified signals, and output the audio current signals to the speaker. The audio current signals drive the speaker and cause the speaker to reproduce the audio signals that are generated by the audio source to create sound.

To amplify the audio signal, the amplifying circuit of the audio amplifier typically requires a bias circuit to provide the bias voltages for biasing the amplifying circuit. However, when the audio amplifier just powers on, the power source, such as the supply voltage, is suddenly applied to the bias circuit, which causes the bias voltage generated by the bias circuit vibrates a lot. As a result, the output audio signal generated according to the bias voltage vibrates as well, which might damage the audio amplifier and produce unpleasant pop noises.

Therefore, there is a need for a new audio amplifier which can prevent the pop noise, and prevent the amplifier circuit from being damaged when the audio power amplifier powers on or powers down.

### SUMMARY

An audio power amplifier is disclosed. According to one embodiment of the present invention, an audio amplifier includes an amplifying circuit, a bias control circuit, and a decoupling device. The amplifying circuit amplifies an audio signal. The bias control circuit provides at least one bias voltage for the amplifying circuit according to a power down signal, in which the power down signal represents that the audio amplifier is powered on or powered down. The decoupling device reduces the damping phenomenon of the bias voltage caused by powering on or powering down the audio amplifier.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 shows the block diagram of the audio amplifier according to one embodiment of the present invention;

FIG. 2A shows the block diagram of the audio amplifier according to another embodiment of the present invention;

FIG. 2B shows the block diagram of the audio amplifier according to the other embodiment of the present invention;

FIG. 3 shows the flow chart of method for playing an audio signal according to the embodiment of the present invention; and

FIG. 4 shows the power down signal waveform and the output audio signal waveform of the audio amplifier according to the embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The decoupling device of the embodiments shown below can stabilize the bias voltage of the audio amplifier, such that the pop noise of the output audio signal can be eliminated.

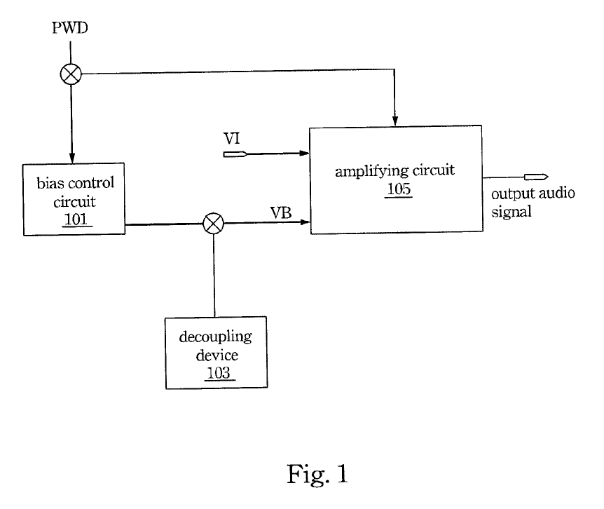

FIG. 1 shows the block diagram of the audio amplifier according to one embodiment of the present invention. The audio amplifier includes an amplifying circuit 105, a bias control circuit 101, and a decoupling device 103. The amplifying circuit 105 amplifies the audio signal VI. The bias control circuit 101 provides at least one bias voltage VB for the amplifying circuit 105 according to the power down signal PWD, in which the power down signal PWD represents that the audio amplifier is powered on or powered down. The decoupling device 103 reduces the damping phenomenon of the bias voltage VB caused when the audio amplifier is powered on or powered down.

When the audio amplifier is just powered on/powered down, the power source is suddenly passed to the bias control circuit 101, the bias control circuit 101 suddenly begins/stops generating the bias voltage VB and passes the bias voltage VB to the amplifying circuit 105. The sudden appearance of the power source produce the damping phenomenon of the bias voltage VB. As a result of the damping phenomenon of the bias voltage VB, the output audio signal vibrates, which causes the undesired pop noise.

To eliminated the undesired pop noise, the decoupling device 103 is added to reduce the damping phenomenon of the bias voltage VB when the audio amplifier powers on or powers down, which in turn eliminates the undesired pop noise of the output audio signal.

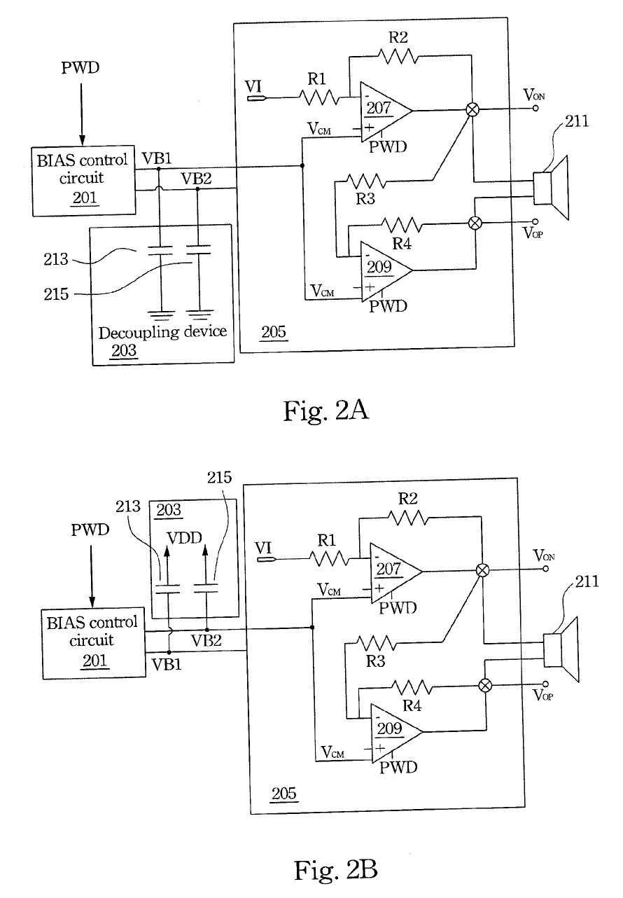

FIG. 2A shows the block diagram of the audio amplifier according to another embodiment of the present invention. The audio amplifier includes an amplifying circuit 205, a bias control circuit 201, and a decoupling device 203. The amplifying circuit 205 amplifies the audio signal VI. The bias control circuit 201 provides bias voltage VB1 and bias voltage VB2 for the amplifying circuit 205.

The decoupling device 203 includes a decoupling capacitor 213 and a decoupling capacitor 215. The decoupling capacitor 213 has one end coupled to the output terminal outputting the bias voltage VB1, and the other end receiving a ground voltage. The decoupling capacitor 215 has one end coupled to the output terminal outputting the bias voltage VB2, and the other end also receiving a ground voltage. The decoupling capacitor 213 and the decoupling capacitor 215 keep the bias voltage VB1 and the VB2 stable, such that the damping phenomenon of the bias voltage VB1 and the bias voltage VB2 can be reduced.

The amplifying circuit 205, amplifying the audio signal VI, includes a first operation amplifier 207 and a second operation amplifier 209. The first operation amplifier 207 generates an inverting output voltage Von according to the audio signal VI. The second operation amplifier 209 generates a non-inverting output voltage Vop according to the inverting output voltage Von and the audio signal VI. The output voltage Vop and the output voltage Von drive the speaker 211 to reproduce the audio signal VI.

The first operation amplifier 207 and the second operation amplifier 209 can be class AB amplifiers, class B amplifiers, or class A amplifiers. The class A amplifier has its power transistors been in conductive states all the time, which means that the power transistors continuously dissipate power. Thereby, the class A amplifier has low power efficiency.

The class B amplifier has its power transistors successively driven between conductive and non-conductive states, therefore, the power transistors of the class B amplifier are operated only 50% of the time. The class AB amplifier has its power transistors been in the conductive state for time period greater than one-half of the total period. Thereby, the power transistors of the Class AB amplifier are operated somewhere between 50% and all of the time period. As a result, because Class AB amplifier and Class B amplifier have better power efficiency, they are used more often in the audio amplifier than class A amplifier.

The amplifying circuit 205 further includes a first resistor R1 a second resistor R2, a third resistor R3, and the fourth resistor R4. The first resistor R1 has one end receiving the audio signal VI, and the other end connected to a negative terminal of the first operation amplifier 207. The second resistor R2 connected between the negative terminal and an output terminal of the first operation amplifier 207. The third resistor R3 has one end connected to the output terminal of the first operation amplifier 207 and the other end connected to a negative terminal of the second operation amplifier 209. The fourth resistor R4 connected between the negative terminal and an output terminal of the second operation amplifier 209. Tuning the resistance of the resistor R1\R2\R3\R4 changes the value of the voltage gain Von/VI and the voltage gain Vop/VI.

FIG. 2B shows the block diagram of the audio amplifier according to the other embodiment of the present invention. The functions of the amplifying circuit 205, the bias control circuit 201, and the decoupling device 203 are similar to the circuits shown in FIG. 2A, except that the decoupling capacitor 213 and a decoupling capacitor 215 are tied to receive the supply voltage VDD, not the ground voltage. The decoupling capacitor 213 and the decoupling capacitor 215, having one end tied to receive the supply voltage VDD, can also store charges and stabilize the bias voltage VB1 and VB2, such that the damping phenomenon of the bias voltage VB1 and VB2 can be reduced, and eliminate the pop noise from the output audio signal as a result.

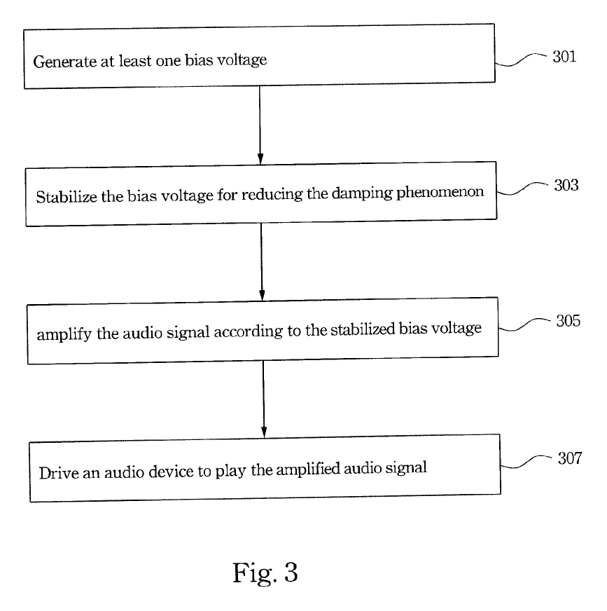

FIG. 3 shows the flow chart of method for playing an audio signal according to the embodiment of the present invention. The method first generates at least one bias voltage (step 301). The bias voltage is then stabilized to reduce the damping phenomenon of the bias voltage (step 303). In step 303, the bias voltage can be stabilized with a decoupling capacitor. After the bias voltage has been stabilized, the method amplifies the audio signal according to the stabilized bias voltage (step 305), and drives an audio device to play the amplified audio signal (step 307). The audio device can be a speaker.

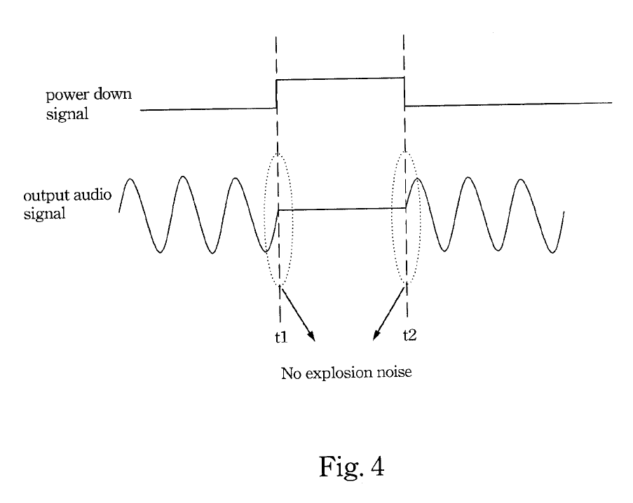

FIG. 4 shows the power down signal waveform and the output audio signal waveform of the audio amplifier according to the embodiment of the present invention. According to the waveform, we can see that the explosion noises of the output audio signal is reduced by adding the decoupling device when the power down signal is asserted at time t1 and de-asserted at time t2.

According to the above embodiments, the decoupling device can reduce the damping phenomenon of the bias voltage of the audio amplifier, such that the pop noise of the output audio signal can be eliminated.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An audio amplifier, comprising:
an amplifying circuit for amplifying an audio signal;
a bias control circuit providing at least one bias voltage for the amplifying circuit according to a power down signal, wherein the power down signal represents that the audio amplifier is powered on or powered down; and
a decoupling device for reducing the damping phenomenon of the bias voltage caused by powering on or powering down the audio amplifier.

2. The audio amplifier as claimed in claim 1, wherein the decoupling device comprises a decoupling capacitor having one end coupled to the bias control circuit and the other end receiving a ground voltage.

3. The audio amplifier as claimed in claim 1, wherein the decoupling device comprises a decoupling capacitor having one end coupled to the bias control circuit and the other end receiving a supply voltage.

4. The audio amplifier as claimed in claim 1, wherein the amplifying circuit comprises:
a first operation amplifier generating an inverting output voltage according to the audio signal; and
a second operation amplifier generating a non-inverting output voltage according to the inverting output voltage and the audio signal.

5. The audio amplifier as claimed in claim 4, wherein the amplifying circuit further comprises:
a first resistor having one end receiving the audio signal and the other end connected to an negative terminal of the first operation amplifier; and
a second resistor connected between the negative terminal and an output terminal of the first operation amplifier.

6. The audio amplifier as claimed in claim 5, wherein the amplifying circuit further comprises:
a third resistor having one end connected to the output terminal of the first operation amplifier and the other end connected to an negative terminal of the second operation amplifier; and
a fourth resistor connected between the negative terminal and an output terminal of the second operation amplifier.

7. The audio amplifier as claimed in claim 4, wherein the first operation amplifier and the second operation amplifier are class AB amplifiers.

8. The audio amplifier as claimed in claim 4, wherein the first operation amplifier and the second operation amplifier are class B amplifiers.

9. The audio amplifier as claimed in claim 4, wherein the first operation amplifier and the second operation amplifier are class A amplifiers.

10. A method for playing an audio signal, comprising:
generating at least one bias voltage;
stabilizing the bias voltage for reducing the damping phenomenon of the bias voltage;
amplifying the audio signal according to the stabilized bias voltage; and
driving an audio device to play the amplified audio signal.

11. The method for playing the audio signal as claimed in claim 10, wherein the bias voltage is stabilized with a decoupling capacitor.

12. The method for playing the audio signal as claimed in claim 10, wherein the audio device is a speaker.

13. The method for playing the audio signal as claimed in claim 10, wherein the amplified audio signal is biased as a class AB signal.

14. The method for playing the audio signal as claimed in claim 10, wherein the amplified audio signal is biased as a class B signal.

15. The method for playing the audio signal as claimed in claim 10, wherein the amplified audio signal is biased as a class A signal.
